(19) United States
(12) Patent Application Publication
(10) Pub. No.: US 2006/0058045 A1
(43) Pub. Date: Mar. 16, 2006

(54) Proximity location

(75) Inventor: Jens Nilsen, Stockholm (SE)

Correspondence Address: NIXON & VANDERHYE, PC, 901 NORTH GLEBE ROAD, 11TH FLOOR, ARLINGTON, VA, 22203, US

(73) Assignee: Buzz AB, Stockholm (SE)

(21) Appl. No.: 10/942,095

(22) Filed: Sep. 16, 2004

(30) Foreign Application Priority Data
Sep. 15, 2004 (SE) 0402216-6

(51) Int. Cl. H04Q 7/20

(52) U.S. Cl. 455/456.5; 455/456.1

(57) ABSTRACT

The invention relates to a system (10) comprising a proximity location service application in a global network for at least one of data- and telecommunication and a network for mobile communication through mobile devices (18, 20, 22), and a method and an electronic memory therefore. The location service application provides matching information about a subscriber within the threshold to a mobile device (18, 20, 22) having had its initialization application operated, thus locating subscribers in a close proximity to each other, having similar personal parameter values.

### TECHNICAL FIELD

The present invention pertains to a system comprising a proximity location service application on demand in a global network for at least one of data- and telecommunication and a network for mobile communication through mobile devices, and a method, an application, and an electronic memory therefore.

### BACKGROUND ART

In the present society where people in common utilize high tech mobile devices such as PDA's, cellular phones, mobile telephones, lap-top computers and other portable devices to communicate for instance over the web such as Internet gives a rise for new personalized services. Also, the use of these devices has too many persons created a gap in social and business contacts. It is easy to communicate with other persons without actually having to meet them in person.

Furthermore, as an example, it is very common to travel for own recreation or in business matters. This means that travelers frequently visit new places, especially business travelers could one day be in New York and the next day in London or in another major city. Thus there is a need to be acquainted to people with like social or business interests when traveling instead of having to spend dull time in hotel lobbies and bars. Of course there exist plenty more reasons for persons to meet in their own city or in other cities or in the country side, and places where they are residential.

Hence, there exists a need for people to rapidly be able to meet each other where ever they are staying or moving around. Currently this can be achieved over the Internet through sites that match people together. This is very well, but still time consuming in order to arrange an actual meeting between persons that would like to meet each other.

### SUMMARY OF THE INVENTION

The aims and goals of the present invention are to provide a rapid technical solution related to matching persons or legal entities with for instance like interest or other motivations to meet where ever they are and at any time on demand.

It is appreciated that the present invention comprises a technical solution to how to localize at least two mobile devices in a given cell area under the premises of having a similar parameter setting for a localization.

To achieve these aims and goals, the present invention sets forth a system comprising a proximity location service application on demand in a global network for at least one of data- and telecommunication and a network for mobile communication through mobile devices. The invention comprises:
at least one database for registration of subscribers to the location service application;
input web interface for personal parameter values of the subscribers in the database for registration of subscribers;
at least one database for continuous registration of the location of registered subscribers mobile telephone devices in the network for mobile communication, fetching the location for every mobile device, being activated to the service in the database for continuous registration;
an initialization interface application in the mobile devices for activating the location service application in the web interface;
an application in the service for mobile devices determining a predetermined close range of distance between mobile devices which initialization has been activated within the network for mobile communication determined through the database for registration of the location of telephone devices;
a matching application for the activated telephone devices determining which mobile telephone devices, which have subscriber registrations with personal parameter values that by a threshold measure most reassemble the subscriber registration parameter values that had its initialization activated; and
the location service application providing matching information about a subscriber within the threshold to a mobile device having had its initialization activated, thus locating subscribers in close range having preferred personal parameter values.

In one embodiment of the present invention the personal parameter values are indexed with numbers or other symbols representing a personal preference.

Another embodiment comprises that the matching application determines a match between subscribers when a predetermined number of parameter values match.

A further embodiment comprises that subscribers have two settings of personal parameter values one for him/her and one for the subscriber to meet.

Yet another embodiment comprises that the web interface has at least one of the following activation levels to choose from:
one for twenty-four hours activation on demand; and
one for activation and deactivation on demand.

Moreover the present invention sets forth a method in a system comprising a proximity location service application on demand in a global network for at least one of data- and telecommunication and a network for mobile communication through mobile telephone devices. The invention comprises the method steps of:
subscriber registration in at least one database to the location service application;
inputting personal parameter values through the web interface of the subscribers in the database for registration of subscribers;
continuous registration in at least one database of the location of registered subscribers mobile telephone devices in the network for mobile communication, fetching the location for every telephone device, being activated to the service in the database for continuous registration;
initialization through the interface in the telephone devices for activating the location service application in the web interface;
determining through an application in the service for telephone devices a predetermined close range of distance between telephone devices which initialization has been activated within the network for mobile communication determined through the database for registration of the location of telephone devices;
matching application of the activated mobile devices determining which mobile devices, which have subscriber registrations with personal parameter values that by a threshold measure most reassemble the subscriber registration parameter values that had its initialization activated; and
providing matching information of the location service application about a subscriber within the threshold to a mobile device having had its initialization activated, thus locating subscribers in close range having preferred personal parameter values.

Also set forth by the present invention is a proximity location service application on demand in a global network for at least one of data- and telecommunication and a network for mobile communication through mobile devices. Thus comprising:
subscriber registration in at least one database to the location service application;
inputting of personal parameter values through the web interface of the subscribers in the database for registration of subscribers;
continuous registration in at least one database of the location of registered subscribers mobile devices in the network for mobile communication, fetching the location for every mobile device, being activated to the service in the database for continuous registration;
determining through an application in the service for mobile devices a predetermined close range of distance between mobile devices which initialization has been activated within the network for mobile communication determined through the database for registration of the location of mobile devices;
matching application of the activated mobile devices determining which mobile devices, which have subscriber registrations with personal parameter values that by a threshold measure most reassemble the subscriber registration parameter values that had its initialization activated; and
providing matching information of the location service application about a subscriber within the threshold to a mobile device having had its initialization activated, thus locating subscribers in close range having preferred personal parameter values.

The present invention furthermore sets forth an electronic memory storing a proximity location service application on demand in a global network for at least one of data- and telecommunication and a network for mobile communication through mobile devices. Hence, comprising the storing of subject matter in accordance with the method steps of:
subscriber registration in at least one database to the location service application;
inputting personal parameter values through the web interface of the subscribers in the database for registration of subscribers;
continuous registration in at least one database of the location of registered subscribers mobile devices in the network for mobile communication, fetching the location for every mobile device, being activated to the service in the database for continuous registration;
determining through an application in the service for mobile devices a predetermined close range of distance between mobile devices which initialization has been activated within the network for mobile communication determined through the database for registration of the location of mobile devices;
matching application of the activated mobile devices determining which mobile devices, which have subscriber registrations with personal parameter values that by a threshold measure most reassemble the subscriber registration parameter values that had its initialization activated; and
providing matching information of the location service application about a subscriber within the threshold to a mobile device having had its initialization activated, thus locating subscribers in close range having preferred personal parameter values.

The method of the present invention also sets forth above system embodiments in accordance with the attached dependent method claims, which also is applicable for the proximity location service application and the electronic memory.

### BRIEF DESCRIPTION OF THE DRAWINGS

Henceforth, the present invention is described by reference to the attached drawings for a better understanding of given examples and embodiments, wherein

FIG. 1 schematically illustrates one embodiment of a system comprising a location service application in accordance with the present invention; and

FIG. 2 schematically in a form with tables illustrates parameter values and indexes in accordance with one embodiment of the present invention.

### DETAILED DESCRIPTION OF PREFERRED EMBODIMENTS

The present invention relates to a location based service utilizing the existing locating features in a mobile and/or cellular telecommunication system, but not necessarily limited to such as GSM and other TDMA (Time Division Multiplex Access) systems, CDMA (Code Division Multiple Access), WCDMA (Wireless CDMA), WLAN (Wireless LAN) with positioning features, and the like, especially it is utilizing the new 3G technology for communication with for instance the Internet from a mobile telephone device, but it is also applicable for 2G and 2,5G communication. A mobile device in regard of the present invention could be any portable device at least comprising radio electronics for making calls in a mobile and/or cellular telecommunication system such as cellular phones, PDA's, lap- and palm-top computers and other devices having call functionality combined with other functions, for example, cameras, GPS (Global Positioning System), real-time video, and data services, FTP down load and other applications known to a person skilled in the art.

In a cellular telecommunication system a mobile device continuously registers its location when attached to the system during roaming through its cells. The location of a mobile device is registered in a HLR (Home Location Register) and/or VLR (Visitor Location Register). These registers reside in a Mobile services Switching Centre (MSC) or like switching centre. It is common that a mobile telephone device is registered with an accuracy radius of approximately 500 meters, often even smaller radius, depending on individual operator cell planning for the area radio coverage in a cell.

Hence, one idea behind the present invention is to utilize the location information of at least two mobile telephone devices in order to locate how close those devices are to each other if certain predetermined preferred parameter values are matching.

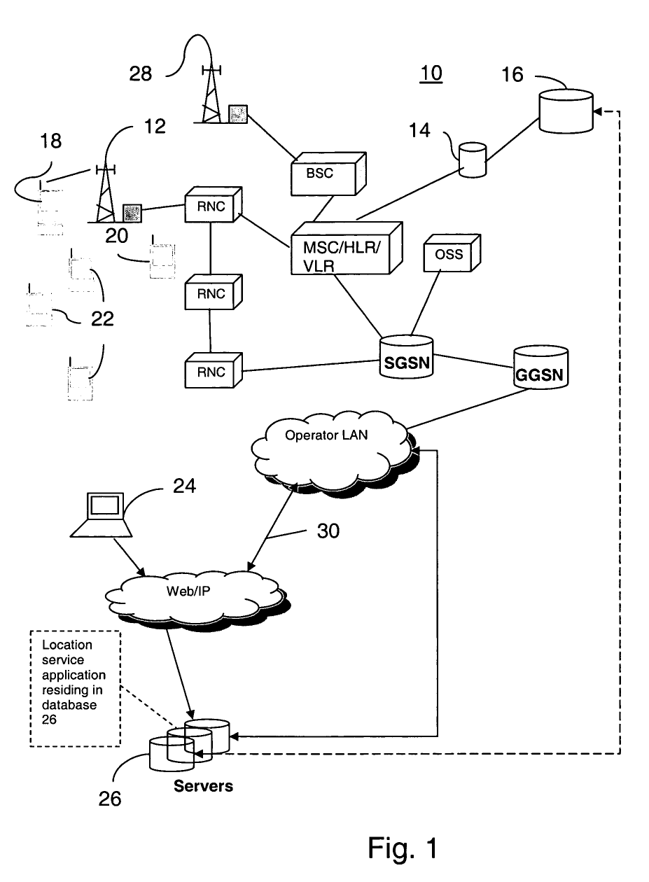

The attached FIG. 1 schematically depicts a system 10 that provides a location service application, indicated by broken lines in FIG. 1, in accordance with the present invention. To be able to use the service a person and/or a legal entity subscribing to it has an initializing/communication interface application residing in his/her mobile telephone device which connects to the service when operated and/or transmits and/or receives messages from the service. Very schematically a prior art cellular network is illustrated in FIG. 1, having multiple (only two depicted) base stations 12 (RNC, 3G standard), 28 (BTS, 2G standard) covering one or multiple cells receiving mobile phone calls which are relayed to Radio Network Controllers (RNC) and Base Station Controller (BSC), Mobile service Switching Centre (MSC) including HLR and VLR registers, Serving GPRS Support Node (SGSN), and Gateway GPRS Support Node (GGSN) as is known to the person skilled in the art. These nodes are 2G and 3G nodes. The 3G standard is presented in www.3GPP.org. There exist other utilized operator customized standards which are applicable within the scope of the present invention.

In order to emphasize the possible use of 2G, a base station 28 and a BSC (Base Station Controller) is depicted in FIG. 1.

To communicate via the TCP/IP protocol, most likely, operator specific network design, an operator internal gateway 14 connects to a location based services (LBS) database 16 for 2G and 3G telephony storing and transmitting subscriber positioning information to the location based service of the present invention for activated subscribers mobile telephone devices.

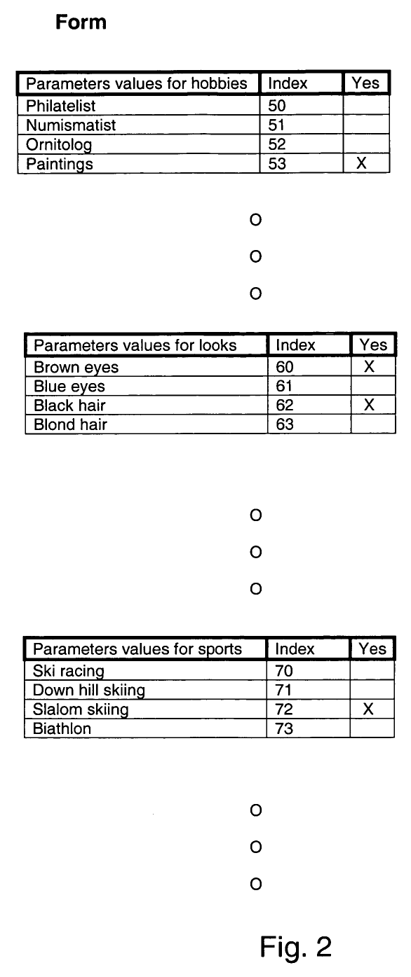

To be able to explain embodiments of the present invention an example including five mobile telephone devices 18, 20, 22 is provided. All these telephone devices 18, 20, 22 through there owners are subscribers to the location service applications of the present invention and thus are comprised with an initialization and communication interface application in the mobile devices 18, 20, 22 for the location service application. There subscribers have registered to the location service applications by login on with for example computer 24, or via any of the mobile devices 18, 20, 22, via the web/IP protocol to servers 26 making up the base comprising the location service application of the present invention where all data of registered subscribers to the services resides, and also providing a home page/web interface where the subscriber is able to register here/his personal parameter values, which will be further described in the following with reference to one embodiment depicted in FIG. 2.

It is assumed in one embodiment that mobile device 18 and its owner is visiting London. The owner has a hobby of being interested in paintings preferably those displayed in museums. Hence, his profile with personal parameter values is stored in the servers 26 location service application. Also, he would like a lady company which shares his interest for paintings. The lady should in accordance with the present invention be in close range to the owner of the telephone device 18 in London, for example, within approximately 500 meters not limiting the invention to these figures. He, the owner of device 18 prefers brown eyes and black hair for his possible lady companionship.

Through the initializing interface application in device 18 for instance by connecting through an icon or button on the display of the device 18 a connection to the location service application of the present invention is established through the operator LAN between servers 26, whereby positioning information of all subscribers in the vicinity of approximately 500 meters is transmitted from LBS server 16 to the base servers 26. In this given example a cluster of telephone devices 20, 22 are within this limit of approximately 500 meter. The next step is to check which personal parameter values that match the preferred parameter values of the subscribing owner of the mobile telephone device 18 among the registered subscribing owners of devices 20, 22. The devices 20, 22 could be recognized by a software application of the location service application for mobiles within the given distance of approximately 500 meters. Herewith, device number 20 has a match of for instance two parameter values, for example paintings and brown eyes but not black hair color. But the threshold value for a match in this example is predetermined to two parameter hits so the owner of device 18 will receive a message from the location service application via servers 26 with particulars about the subscriber and owner of device 20 comprising information of how to reach each other, which is in the proximity of where they are residing in London.

It is appreciated that threshold values for parameter matching and personal parameter settings can vary in number and categories. FIG. 2 now provides one embodiment of how personal parameter settings can be accomplished for a matching. The FIG. 2 illustrates three tables in a form of possible personal parameter values, which tables are divided by circular dots meaning that other tables are possible and likely to appear in a complete listing of personal parameter values in accordance with the present example. These tables are filled out via the utilization of for instance the computer 24, but it is understood that other mobile devices that are able to connect to the world wide web such as 2G and 3G equipped mobile telephone devices 18, 20, 22 could be utilized for registration and subscription to the location service application of the present invention thus communicating with the location service applications residing in the database 26 through line connection 30 wire or wireless. A connection to the Internet could be accomplished through prior art techniques involving for instance the wireless application protocol (WAP) through general packet radio service (GPRS) and like protocols and techniques for wireless telecommunication. In a manual registration service to the location service application of the present invention residing in server(s) 26, it is possible to register through a phone call, whereby staff personnel for the database 26 fill in the form in the web interface.

Hence, FIG. 2 depicts the preferences of parameter values for owner of mobile device 18 through the headings “Parameter values for hobbies”, “Parameter values for looks”, and “Parameter values for sports”. The threshold in this example for match with a person such as device owner 20 was set to two matching parameter values. In this example parameter values painting and brown eyes matched which made the location service application of the present invention to transmit particulars of the owner of device 20 to the contact seeking owner of device 18. As can be seen from the tables of FIG. 2 all parameter values are given a different index number, and the subscribers have marked there preferences with an X for those personal parameter values for persons that they possible would like to meet when they are in a predetermined close locating area in, for example, a cellular mobile telecommunication system. In this manner people who would like to socialize with other people instantly can meet at any place. It is also appreciated that the parameter values and its indexes could be of any suitable type and number.

A matching of parameter values is thus accomplished by for instance comparing X marked parameter values with their assigned index number . . . , 50, 51, . . . 60, 61 . . . , 70, 71 . . . , which is accomplished through for instance a software matching application, digitally. The parameter indexes could also be symbols such as alpha-numeric or other known characters, which also could be encoded. It is appreciated that a subscriber 18, 20, 22 in one embodiment of the present invention, although not depicted in FIG. 2, could have two settings of personal parameter values one for him-/herself and one for the subscriber to meet, for example, see looks in FIG. 2. There a person could have one parameter setting for own looks and one for the person to meet, which also is applicable for other parameter values than looks. This can be accomplished through a form having two sets of tables one for own parameter values and one for parameter values to search for.

Hence, the present invention sets forth a system 10 comprising a proximity location service application on demand in a global network for at least one of data- and telecommunication and a network for mobile communication through mobile devices 18, 20, 22. Hence, it comprises at least one database 26 for registration of subscribers to the location service application, and an input web interface for personal parameter values of the subscribers in the database 26 for registration of subscribers. Moreover, comprising at least one database 16 for continuous registration of the location of registered subscribers mobile devices 18, 20, 22 in the network for mobile communication, fetching the location for every mobile device 18, 20, 22, being activated to the service in the database 16 for continuous registration, and an initialization interface in the mobile devices for activating the location service application in the web interface. Furthermore it comprises an application in the service for mobile devices 20, 22 determining a predetermined close range of distance between mobile devices 18 which initialization has been activated within the network for mobile communication determined through the database 16 for registration of the location of mobile devices 18, 20, 22, and a matching application for the activated mobile devices 20, 22 determining which mobile devices that have subscriber registrations with personal parameter values that by a threshold measure most reassemble the subscriber registration parameter values that had its initialization activated. The present invention thus accomplishes that the location service application provides matching information about a subscriber within the threshold to a mobile device 18, 20, 22 having had its initialization application activated, thus locating subscribers in close range having preferred personal parameter values.

The present invention also sets forth a proximity location service application and an electronic memory in accordance with the above technology.

A possible scenario for meeting other persons by locating mobile devices 18, 20, 22 which are in close range could follow the following path from registering as a subscriber to a match of personal parameter values and a possible meeting:
Want company?
How do I proceed?
Can I specify a person?
Log on to, www.netmatch®.nu
Register!
Use the computer!
Create your own profile on the web!
What is the next step?
Use your 3G/2G to log in!
Say “Yes” I would like to have a notification!
. . . the search starts . . . !!!!
You are walking in a city . . .
There is a ping in your mobile device 18, an incoming SMS, . . . a candidate is found!
Candidate is close, in approximately 500 meters!
. . . do you want to continue and know more?
I would like to know more.
Download more information. . . .
Reception of further information of the possible candidate(s)!
   Picture
   Personal characteristics
   Hobbies
   Information about how to contact
Evaluation of information received
Meeting the candidate?
SMS or call candidate(s)
Now it is up to you for a possible meeting.

The present invention provides further embodiments to a person skilled in the art taking into account the attached set of claims.

1. A system comprising a proximity location service application on demand in a global network for at least one of data- and telecommunication and a network for mobile communication through mobile devices, comprising:
at least one database for registration of subscribers to said location service application;
input web interface for personal parameter values of said subscribers in said database for registration of subscribers;
at least one database for continuous registration of the location of registered subscribers mobile devices in said network for mobile communication, fetching the location for every mobile device, being activated to said service in said database for continuous registration of location;
an initialization interface application in said mobile devices for activating said location service application in said web interface;
an application in said service for mobile devices determining a predetermined close range of distance between mobile devices which initialization has been activated within said network for mobile communication determined through said database for registration of the location of mobile devices;
a matching application for said activated mobile devices determining which mobile devices, having subscriber registrations with personal parameter values that by a threshold value most reassemble the subscriber registration parameter values that had its initialization activated; and
said location service application providing matching information about a subscriber within the threshold to a mobile device having had its initialization activated, thus locating subscribers in close range having preferred personal parameter values.

2. A system according to claim 1, wherein said personal parameter values are indexed with numbers or other symbols representing a personal preference.

3. A system according to claim 2, wherein said matching application determines a match between subscribers when a predetermined number of parameter values match.

4. A system according to claim 1, wherein said subscribers have two settings of personal parameter values one for him-/herself and one for the subscriber to meet.

5. A system according to claim 1, wherein said web interface has at least one of the following activation levels to choose from:
one for twenty-four hours activation on demand; and
one for activation and deactivation on demand.

6. A method in a system comprising a proximity location service application on demand in a global network for at least one of data- and telecommunication and a network for mobile communication through mobile devices, comprising the method steps of:
subscriber registration in at least one database to said location service application;
inputting personal parameter values through said web interface of said subscribers in said database for registration of subscribers;
continuous registration in at least one database of the location of registered subscribers mobile devices in said network for mobile communication, fetching the location for every mobile device, being activated to said service in said database for continuous registration;
initialization through said interface in said mobile devices for activating said location service application in said web interface;
determining through an application in said service for mobile devices a predetermined close range of distance between mobile devices which initialization has been activated within said network for mobile communication determined through said database for registration of the location of mobile devices;
matching application of said activated mobile devices determining which mobile devices, which have subscriber registrations with personal parameter values that by a threshold measure most reassemble the subscriber registration parameter values that had its initialization activated; and
providing matching information of said location service application about a subscriber within the threshold to a mobile device having had its initialization activated, thus locating subscribers in close range having preferred personal parameter values.

7. A method according to claim 6, wherein said personal parameter values are indexed with numbers or other symbols representing a personal preference.

8. A method according to claim 7, wherein said matching application determines a match between subscribers when a predetermined number of parameter values match.

9. A method according to claim 6, wherein said subscribers have two settings of personal parameter values one for him-/herself and one for the subscriber to meet.

10. A method according to claim 6, wherein said web interface has at least one of the following activation levels to choose from:
one for twenty-four hours activation on demand; and
one for activation and deactivation on demand.

11. A proximity location service application on demand in a global network for at least one of data- and telecommunication and a network for mobile communication through mobile devices, comprising:
subscriber registration in at least one database to said location service application;
inputting of personal parameter values through said web interface of said subscribers in said database for registration of subscribers;
continuous registration in at least one database of the location of registered subscribers mobile devices in said network for mobile communication, fetching the location for every mobile device, being activated to said service in said database for continuous registration;
determining through an application in said service for mobile devices a predetermined close range of distance between mobile devices which initialization has been activated within said network for mobile communication determined through said database for registration of the location of mobile devices;
matching application of said activated mobile devices determining which mobile devices, which have subscriber registrations with personal parameter values that by a threshold measure most reassemble the subscriber registration parameter values that had its initialization activated; and
providing matching information of said location service application about a subscriber within the threshold to a mobile device having had its initialization activated, thus locating subscribers in close range having preferred personal parameter values.

12. A proximity location application according to claim 11, wherein said personal parameter values are indexed with numbers or other symbols representing a personal preference.

13. A proximity location application according to claim 12, wherein said matching application determines a match between subscribers when a predetermined number of parameter values match.

14. A proximity location application according to claim 11, wherein said subscribers have two settings of personal parameter values one for him-/herself and one for the subscriber to meet.

15. A proximity location application according to claim 11, wherein said web interface has at least one of the following activation levels to choose from:
one for twenty-four hours activation on demand; and
one for activation and deactivation on demand.

16. An electronic memory storing a proximity location service application on demand in a global network for at least one of data- and telecommunication and a network for mobile communication through mobile devices, comprising the storing of subject matter in accordance with the method steps of:
subscriber registration in at least one database to said location service application;
inputting personal parameter values through said web interface of said subscribers in said database for registration of subscribers;
continuous registration in at least one database of the location of registered subscribers mobile devices in said network for mobile communication, fetching the location for every mobile device, being activated to said service in said database for continuous registration;
determining through an application in said service for mobile devices a predetermined close range of distance between mobile devices which initialization has been activated within said network for mobile communication determined through said database for registration of the location of mobile devices;
matching application of said activated mobile devices determining which mobile devices, which have subscriber registrations with personal parameter values that by a threshold measure most reassemble the subscriber registration parameter values that had its initialization activated; and
providing matching information of said location service application about a subscriber within the threshold to a mobile device having had its initialization activated, thus locating subscribers in close range having preferred personal parameter values.

17. An electronic memory according to claim 16, wherein said personal parameter values are indexed with numbers or other symbols representing a personal preference.

18. An electronic memory according to claim 17, wherein said matching application determines a match between subscribers when a predetermined number of parameter values match.

19. An electronic memory according to claim 16, wherein said subscribers have two settings of personal parameter values one for him-/herself and one for the subscriber to meet.

20. An electronic memory according to claim 16, wherein said web interface has at least one of the following activation levels to choose from:
one for twenty-four hours activation on demand; and
one for activation and deactivation on demand.
